(19) United States
(12) Patent Application Publication
(10) Pub. No.: US 2025/0076490 A1
(43) Pub. Date: Mar. 6, 2025

(54) MILLIMETER WAVE IMAGING SYSTEM FOR WAREHOUSE AUTOMATION

(71) Applicant: THRUWAVE INC., Seattle, WA (US)

(72) Inventors: Matthew S. REYNOLDS, Seattle, WA (US); Pieter KRYNAUW, Seattle, WA (US); Claire WATTS, Seattle, WA (US); Andreas PEDROSS-ENGEL, Seattle, WA (US)

(21) Appl. No.: 18/724,557

(22) PCT Filed: Dec. 21, 2022
(86) PCT No.: PCT/US2022/053688

§ 371 Date: Jun. 26, 2024

Related U.S. Application Data
(60) Provisional application No. 63/293,943, filed on Dec. 27, 2021.

(51) Int. Cl. G01S 13/90; G01S 7/41

(52) U.S. Cl. CPC G01S 13/90; G01S 7/41

(57) ABSTRACT

A system for producing a millimeter wave image of an object, the system including: a storage unit including a material at least partially transparent to millimeter waves and configured to contain the object; a millimeter wave sensor providing millimeter wave data, the sensor including: an array of millimeter wave transmitting antennas; and an array of millimeter wave receiving antennas; one or more processors; and one or more memory devices having stored thereon instructions that when executed by the one or more processors cause the one or more processors to: receive the millimeter wave data from the sensor; generate estimated positions of the millimeter wave sensor relative to the storage unit, wherein the millimeter wave sensor and the storage unit are in relative motion; and process the millimeter wave data and the estimated positions to produce the millimeter wave image of the object.

### CROSS-REFERENCE TO RELATED APPLICATIONS

This application claims priority to and the benefit of U.S. Provisional Patent Application No. 63/293,943, filed Dec. 27, 2021, the disclosure of which is incorporated herein by reference in its entirety.

### TECHNICAL FIELD

The present disclosure relates to systems and methods for millimeter wave imaging systems used in warehouse automation.

### SUMMARY

An automated storage and retrieval system (ASRS) may comprise a collection of individual storage units such as totes, bins, trays, bags, pouches, or boxes, each of which may be used to store items for later retrieval. Storage units may also comprise pallets carrying one or more items, which may themselves be contained in totes, bins, trays, bags, pouches, or boxes. One aspect of an ASRS is a database comprising records pertaining to the contents of the storage units and to the logical and/or physical locations of the storage units within the system. Examples of ASRS comprising one or more millimeter wave (mmWave) imaging sensors are described, in which ASRS database records are updated at least in part due to outputs of mmWave imaging sensors. In some examples, mmWave imaging sensors are employed to sense the presence or absence of a storage unit at a particular physical location in an ASRS. In further examples, mmWave imaging sensors are employed to determine a volumetric utilization of one or more storage units, or to determine a volumetric utilization of the ASRS as a whole. In still further examples, mmWave imaging sensors are employed to count items in storage units, detect missing or damaged items in storage units, and/or detect leaks within storage units. Additionally, mmWave imaging sensors may be used to detect damage to the storage units, such as crushed, dented, or otherwise damaged storage units. mmWave imaging sensors may have a form factor similar to a storage unit, enabling the ASRS to carry the sensors throughout the volume of the ASRS and thus enable the sensors to scan the contents of other storage units while the sensors are carried throughout the system. mmWave imaging sensors may also be mounted at one or more fixed locations throughout an ASRS to image storage units as they are carried throughout a facility by transport units such as shuttles or other robotic units.

In some aspects, the techniques described herein relate to a system for producing a millimeter wave image of an object, the system including: a storage unit including a material at least partially transparent to millimeter waves and configured to contain the object; a millimeter wave sensor providing millimeter wave data, the sensor including: an array of millimeter wave transmitting antennas; and an array of millimeter wave receiving antennas; one or more processors; and one or more memory devices having stored thereon instructions that when executed by the one or more processors cause the one or more processors to: receive the millimeter wave data from the sensor; generate estimated positions of the millimeter wave sensor relative to the storage unit, wherein the millimeter wave sensor and the storage unit are in relative motion; and process the millimeter wave data and the estimated positions to produce the millimeter wave image of the object.

In some aspects, the techniques described herein relate to a system wherein the storage unit is carried by a transport unit. In some aspects, the techniques described herein relate to a system wherein the millimeter wave sensor is carried by a transport unit. In some aspects, the techniques described herein relate to a system wherein the millimeter wave sensor is carried by a first transport unit and the storage unit is carried by a second transport unit. In some aspects, the techniques described herein relate to a system further including instructions to uplink the millimeter wave image to an image analysis processor via a wireless network. In some aspects, the techniques described herein relate to a system wherein the millimeter wave sensor is disposed on at least one face of a transport enclosure that has substantially the same size and shape as the storage unit and wherein the transport enclosure is carried by a transport unit. In some aspects, the techniques described herein relate to a system wherein the one or more processors are contained within the transport enclosure and further including instructions to uplink the millimeter wave image to an image analysis processor via a wireless network. In some aspects, the techniques described herein relate to a system wherein the transport enclosure includes an adapter that enables the millimeter wave sensor to mechanically connect to the transport unit using at least one attachment point in common with the storage unit. In some aspects, the techniques described herein relate to a system wherein the millimeter wave sensor is powered by a battery or supercapacitor carried by the transport unit and wherein the battery or supercapacitor is recharged by electrical contact or by magnetic induction. In some aspects, the techniques described herein relate to a system wherein an image analysis processor is co-located with the processor. In some aspects, the techniques described herein relate to a system wherein the one or more processors is instantiated in a virtual machine of a cloud computing service. In some aspects, the techniques described herein relate to a system wherein the image analysis processor is instantiated in a virtual machine of a cloud computing service. In some aspects, the techniques described herein relate to a system further including a motion estimation system that includes an optical tracking system wherein the estimated positions are determined by reference to a visual feature. In some aspects, the techniques described herein relate to a system wherein the visual feature includes a barcode, a QR code, or a two-dimensional barcode. In some aspects, the techniques described herein relate to a system further including a motion estimation system that includes an RFID tracking system wherein the estimated positions are determined by reference to an RFID tag. In some aspects, the techniques described herein relate to a system further including a motion estimation system that includes a regular pattern of holes, depressions, or projections along a path traveled by the transport unit, wherein the regular pattern of holes, depressions, or projections are read by a switch, a magnetic sensor, or an optical sensor. In some aspects, the techniques described herein relate to a system further including a motion estimation system that includes an inertial measurement unit and wherein the estimated positions are determined at least in part by the inertial measurement unit. In some aspects, the techniques described herein relate to a system further including instructions to determine an estimated volume utilization of the storage unit based at least in part upon the millimeter wave image. In some aspects, the techniques described herein relate to a system further including instructions to compare the millimeter wave image of the storage unit to a previously acquired millimeter wave image of one or more items expected to be present within the storage unit and wherein a result of the comparison is used to update a database entry associated with the storage unit to include the result. In some aspects, the techniques described herein relate to a system wherein an output of the one or more processors is used to update a database entry associated with the storage unit to include an item count, an indication of a missing item, an indication of a damaged item, an indication of damage to the storage unit, or an indication of a liquid leak, at least in part due to the millimeter wave image of the storage unit.

### BRIEF DESCRIPTION OF THE DRAWINGS

FIG. 1 illustrates an example millimeter wave (mmWave) imaging system for warehouse automation including storage units and a storage system, according to some embodiments of the disclosed technology.

FIG. 2 illustrates an example mmWave imaging system including a transport unit, a mmWave sensor, and one or more storage units forming a storage system, according to some embodiments of the disclosed technology.

FIG. 3 illustrates an example of the data and control paths through a mmWave imaging system along with certain components thereof, according to some embodiments of the disclosed technology.

FIG. 4 illustrates another example of the data and control paths through a mmWave imaging system along with certain elements thereof including cloud computing elements and one or more databases, according to some embodiments of the disclosed technology.

FIG. 5 illustrates a further example of the data and control paths through a mmWave imaging system, including certain elements thereof and including cloud computing elements and one or more databases, according to some embodiments of the disclosed technology.

FIG. 6 illustrates an example of a mmWave imaging system including an image analysis processor and image analysis modules and one or more databases, according to some embodiments of the disclosed technology.

FIG. 7 illustrates an example of a mmWave imaging system as installed on a transport unit including an adapter, according to some embodiments of the disclosed technology.

FIG. 8 illustrates an example of a mmWave imaging sensor including transmitting and receiving signal paths, according to some embodiments of the disclosed technology.

FIG. 9 illustrates an example of a mmWave imaging system including a transport unit, a mmWave sensor, and one or more storage units forming a storage system, according to some embodiments of the disclosed technology.

### DETAILED DESCRIPTION

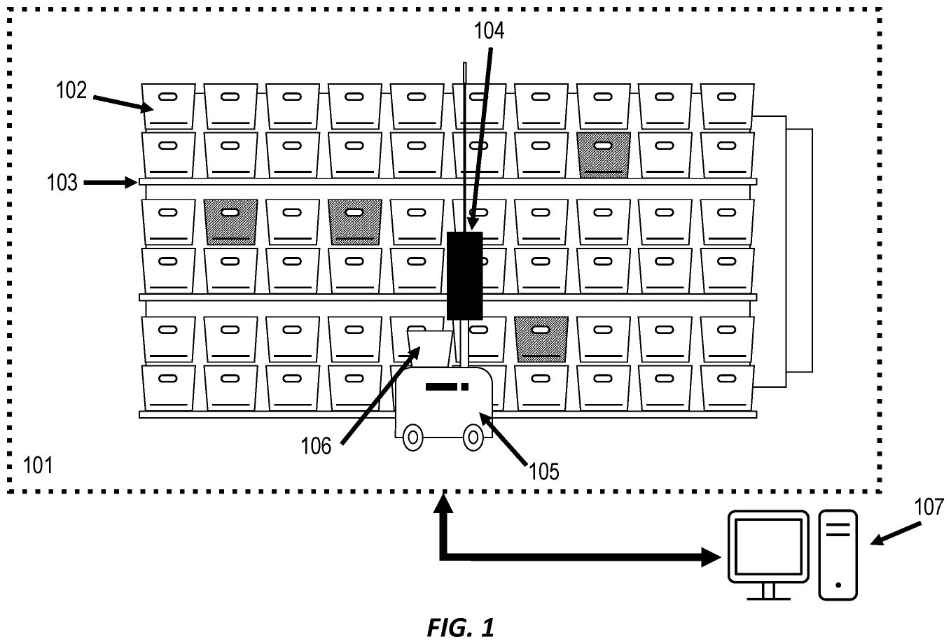

Material handling facilities include such facilities as warehouses, distribution centers, fulfillment centers, and the like. As shown in FIG. 1, such facilities often include storage systems 101 enabling items to be held until they are needed to fulfill an order. In many storage systems, individual storage units 102 such as totes, bins, trays, or boxes, are held on shelves or racks 103. The storage units contain the items being stored within the material handling facility. Storage units 102 may also comprise pallets carrying one or more items, which may themselves be contained in totes, bins, trays, bags, pouches, or boxes. Such items may include mechanical or electrical components, spare parts for machinery such as automobiles or aerospace vehicles, consumer packaged goods, packaged food or beverage items, fresh foods such as produce, meats, or dairy items, or any other type of goods produced or sold in commerce. Further examples may include automated storage and retrieval systems holding information in the form of books or papers, or digital or analog storage media such as computer tapes, motion picture films, etc.

In some examples, storage systems 101 hold the items under controlled environmental conditions, such as temperature control, humidity control, vibrational control, or a controlled atmosphere. In some examples, temperature and humidity control may be employed to preserve perishable items such as fresh foods. In further examples, a controlled atmosphere may include an atmosphere in which the presence or absence of certain gases may be maintained, for example an atmosphere in which the carbon dioxide or ethylene gas concentration is maintained at a desired level to cause produce to ripen in a controlled manner.

An automated storage and retrieval system (ASRS) refers to a storage system, such as that shown as 101, in which electromechanical automation is used to facilitate the introduction of items into the storage system, the manipulation of items while in the storage system, and/or the extraction of items from the storage system. Such ASRS systems may comprise a wide range of different automation technologies including transport units 105. Some examples of transport units 105 include “shuttle” or “bot” systems, where robotic vehicles travel along fixed paths (such as wheeled tracks) around a facility and move storage units as needed to introduce, manipulate, or extract storage units when required to fill an order. Other examples of transport units 105 include autonomous mobile robot (AMR) systems where storage units are carried by autonomous or semi-autonomous robots on varying paths around a facility to accomplish the same goals. Further examples of transport units 105 include stacker cranes, carousel, or pod-type systems for storing and retrieving items. Such vehicles or mechanisms that transport storage units may be referred to generically as a transport unit.

An ASRS may move storage units throughout the facility in various ways. In some examples, transport units 105 such as shuttles or bots traverse tracks or rails arranged along the edges of shelving units. The transport units pick up storage units and carry them along the tracks or rails, as shown by the storage unit 106 being carried by transport unit 105.

In some examples, tracks or rails provide electrical power to the transport units via electrification of the tracks or rails themselves, or via conductors arranged along the tracks or rails. Magnetic induction may also be employed to provide power to transport units. Batteries or supercapacitors contained within the transport units may be recharged by such power distribution schemes to enable the transport units to operate for some period of time when a supply of electrical power is not available. In other examples, more versatile transport units, such as autonomous mobile robots, may carry storage units more autonomously, with free form motion throughout the facility. In such examples, the mobile robots may also carry batteries or supercapacitors that are recharged either via contact or using induction to enable them to move throughout the facility in an untethered manner. In some examples, a transport unit may employ a mechanism such as a conveyor belt to carry storage units throughout a facility.

### Storage System Databases

An aspect of any storage system 101 is the ability to maintain an accurate mapping between a given storage unit 102 (such as a tote, bin, tray, or box, or a pallet of items), the items stored within the storage unit, and the physical and/or logical location of the storage unit within a storage system. For example, a traditional warehouse facility may comprise long aisles of shelving or racking 103, onto which storage units 102 are placed. Each storage unit 102 may be empty from time to time, but more often contains some number of items. In some examples, each storage unit 102 contains a homogeneous collection of items, but in other examples, the storage units 102 contain a heterogeneous mixture of items. In some facilities, storage units 102 containing like items are located in physical proximity to each other. However, in other facilities, the physical locations of storage units, and the physical locations of items, are deliberately randomized to avoid creating bottlenecks that slow access to frequently ordered items. The physical locations of storage units, and the physical locations of items among the storage units, may be managed by a control system 107 that optimizes the throughput of the storage system 101, for example by placing frequently ordered items closer to the doors of the facility to minimize the time spent searching for and retrieving frequently ordered items. In some examples where perishable items are stored, the items may be stored in a first-in first-out configuration to ensure that the perishable items do not expire during storage.

In many storage systems 101, the mapping between the storage unit, the items stored within, and the physical and/or logical location of the storage units are kept in a database which may be in communication with control system 107. This database is sometimes said to comprise a “digital twin” of the warehouse because it is a digital representation of the physical facility. Maintaining the integrity of the information stored in the database can facilitate efficient operation of the facility. A mismatch between the identity, state, and/or location of the items as represented in the database, and the physical identity, state, and/or location of the physical items in the facility may cause many problems. Some examples of the problems that can be caused by such a mismatch include the inability to fulfill an order because of the inability to find the correct location of an item, or the inability to fulfill an order in a specified time window due to the inability to extract the item within the allowable time. Further problems may include the unexpected expiration or spoilage of items because they are kept in the facility too long, e.g. if the first-in first-out configuration is not maintained due to database mismatches among similar products with different expiration dates.

Ultimately, the business consequences of such database mismatches can include unhappy customers, lost revenue, excessive inventory costs, excessive shipping and/or storage costs. Further consequences of database mismatch problems may include poor overall utilization of a facility, wherein the amount of physical space consumed by a facility is in excess of the optimal amount of physical space, thus causing higher real estate costs, labor costs, and/or maintenance costs.

In a traditional warehouse, human labor is employed to perform periodic audits of a storage system to attempt to maintain the integrity of the information stored in the database, including techniques such as periodic sampling, or cycle counting. However, manual auditing or cycle counting can be very time consuming and expensive and thus impractical given the large number of different items that may be stored in a facility. Some facilities may include hundreds of thousands to millions of individual items, which may be of hundreds of thousands of different types (sometimes referred to by stock keeping units or SKUs). In such large facilities having such diverse items, it may be infeasible to perform a meaningful degree of sampled auditing or cycle counting.

In some examples, sensors may be employed to either periodically or continuously scan the storage units in the facility to audit the contents of each storage unit. In some examples, such sensors may include barcode readers, optical cameras (either 2D cameras or 3D “depth cameras”), or radiofrequency identification (RFID) readers. However, each of these types of sensors has significant limitations that prevent them from being a generalized solution to the problem of auditing the items inside storage units. For example, barcode readers and optical cameras are both optical sensors that suffer from occlusion, either by opaque materials comprising the storage unit (such as opaque plastic totes, opaque plastic bins or trays, or opaque corrugated boxes), or by the opacity of the individual items themselves, for example when items are jumbled together and one item obscures the barcode of another. RFID readers require that the storage units 102 and/or individual items to be tagged with RFID tags, which may be too costly or infeasible given the large number of manufacturers for different item types. Furthermore, RFID tags may not function properly when affixed to liquids or metal objects. And RFID readers are also typically unable to localize a tagged item to sufficient precision to determine whether an item is contained within a given storage unit 102, or is instead contained within a neighboring storage unit.

While the problem of occlusion prevents optical sensors (such as cameras or barcode readers) from obtaining data from the packaging of individual items (since storage units 102 are typically made of opaque materials), the occlusion problem is often less severe when considering the identification of individual storage units. In such cases, the storage unit 102 itself (such as a tote, bin, tray, or box) may be inexpensively and efficiently labeled with a barcode label along an outer surface of the storage unit 102. There is usually much greater control over the faces of the storage unit 102 that are visible to the automation system because the mobile platform typically places the storage unit in a carefully controlled manner. For example, a duplicate barcode label may be placed on the front and the top surface of a storage unit to allow the label to be read from above, or in front, where occlusion is less of an issue. In many examples, a “license plate number” or LPN is encoded into the barcode label to uniquely identify a particular storage unit and enable the ASRS database to maintain a record of the location of the storage unit as well as the items contained within it.

An alternative type of sensor that may be employed to scan the storage units in a facility is a millimeter wave (mmWave) imaging system 104.

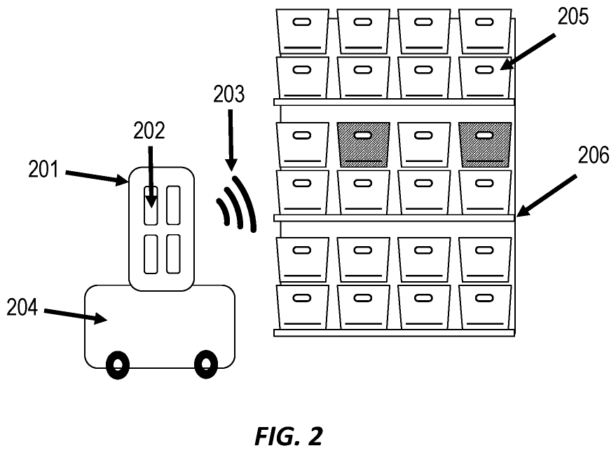

As shown in detail in FIG. 2, a mmWave imaging system may be comprised of one or more mmWave imaging sensors 202 arranged to form the mmWave sensor array 201. The imaging sensors 202 emit mmWave radio frequency signals 203 which pass through storage units 205 arranged on shelving or racking 206, and enable mmWave imaging of the contents of the storage unit. The sensor array 201 may be carried by transport unit 204.

mmWave Image Sensors and Imaging Systems

A mmWave imaging sensor may employ mmWave radio signals in a frequency band ranging anywhere from 15 GHz to 300 GHz to form two dimensional (2D) or three dimensional (3D) images of the contents of a storage unit such as a tote, bin, tray, or box. Because storage units are often fabricated from plastic materials, paper, wood, fabric, or corrugated cardboard, all of which are generally transparent to mmWave signals, a millimeter wave imaging sensor may be able to image the contents of a storage unit even though the storage unit is opaque to optical sensors such as cameras or barcode readers. Materials that are transparent to mmWave signals generally include non-metallic materials having a relative dielectric constant of 10 or lower, and/or thin non-metallic materials having higher dielectric constant. Such materials as plastic materials, paper, wood, fabric, or corrugated cardboard meet these criteria and may be considered to be transparent to mmWave signals. Image contrast is often a function of the relative dielectric constant of the materials within the scene. In general, packaging having a low dielectric constant, and thin cross-section, will enable improved transparency and better image contrast relative to thicker packaging materials with higher dielectric constants.

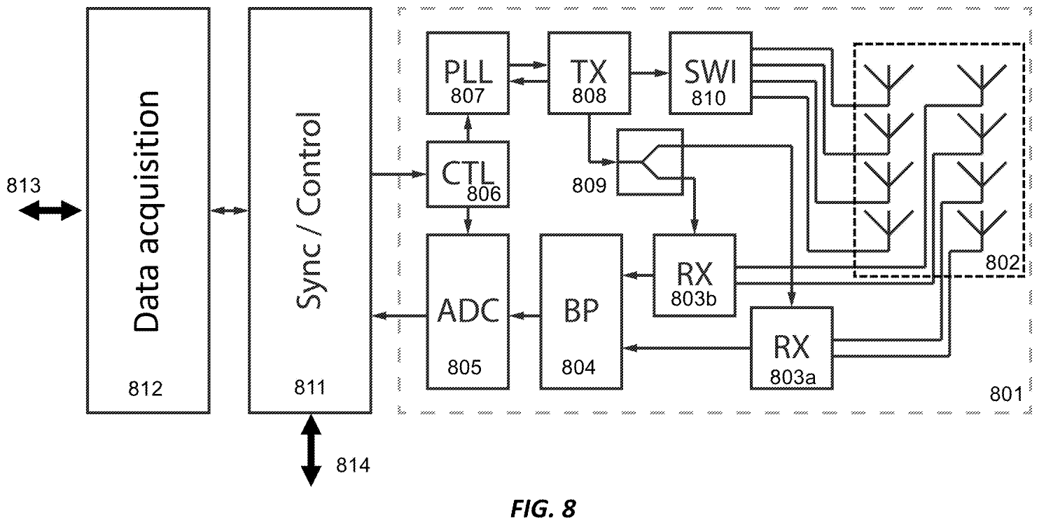

As shown in FIG. 8, in some examples, a mmWave imaging sensor 801 employs an array of transmitting and receiving antennas 802. The transmitting antennas may be fed from one or more transmitters 808 via one or RF switches 810, and may emit millimeter wave energy which is radiated toward the object(s) being imaged. The receiving antennas collect the energy scattered or reflected by the object(s) being imaged, and the collected reflections may be received by receivers 803a and 803b. The received signals may be amplified and filtered by bandpass filter 804 and then fed to analog-to-digital converter (ADC) 805.

Phase locked loop (PLL) frequency synthesizer 807 locks the mmWave signal produced by transmitter 808 to yield the mmWave carrier in the desired frequency band as described herein. The mmWave carrier is then fed to the transmitter 808 as well as to receivers 803a and 803b via RF power splitter 809.

Controller 806 may employ digital logic, such as that implemented in a field programmable gate array (FPGA), a microprocessor, or a microcontroller, to control the operation of the transmitter 808, the RF switch 810, the receivers 803a and 803b, the ADC 805, and other components of the sensor.

Synchronization and control system 811 controls the operation of mmWave sensor 801 as well as any other sensors via a digital control bus 814. In some examples, synchronization and control system 811 coordinates the frequency allocations among multiple sensors to enable their simultaneous operation while minimizing mutual interference among them. Synchronization and control system 811 may also communicate with controller 806 to coordinate the RF switches 810, the PLL 807, and the sampling operation of the ADC 805 to ensure synchronous sampling of the data produced by mmWave sensor 801 along with other mmWave sensors via digital control bus 814.

Data acquisition system 812 collects the data produced by the mmWave sensors and produces a digital output stream 813 which may be further processed by an image reconstruction processor to yield a 2D or 3D mmWave image as described herein.

Analog-to-digital converter (ADC) 805 produces sampled data which may include a complex-valued transfer function relating the magnitude and phase of the signals received at the receiving antennas, as a function of the frequency transmitted by the transmitting antennas. This sampled data is then processed by an image reconstruction processor to yield a 2D or 3D mmWave image as described herein.

The array of transmitting and receiving antennas 802 may be partitioned into sub-arrays of convenient dimensions that permit cost-effective manufacturing and testing. In one example, a sub-array may comprise eight transmitting antennas and eight receiving antennas, but it should be appreciated that other sub-array partitions are also suitable. Many such sub-arrays may be assembled into a single sensor unit. In some examples, the sub-arrays comprise sensor modules which may include the transmitting and receiving antenna elements, transmit and receive signal paths, frequency synthesis circuitry, analog-to-digital conversion circuitry, and digital interface circuitry. In some examples, the sensor modules are controlled by a concentrator unit including synchronization and control system 811 that synchronizes the activity of the sensor modules, coordinates the transmission frequency and any frequency sweep parameters among modules, and collects the digitized data from each of the sensor modules. The concentrator unit may comprise a combination of digital logic, as may be implemented in a field programmable gate array (FPGA) as well as an embedded computer such as one or more ARM Inc. microprocessor cores and their associated non-volatile Flash memory and random-access memory (RAM). The concentrator may perform key real-time operations of the imaging system such as triggering the imaging system when a storage unit passes into the field of view of the imaging system, or integrating with other real-time sensors. The concentrator may queue the sensor data into packets which can be sent over a computer network such as an Ethernet network. In some examples, transmission control protocol/internet protocol (TCP/IP) and/or user datagram protocol (UDP) packets may contain the sensor data packets and any associated control or trigger information, and these packets may be exchanged with an image reconstruction processor over a gigabit Ethernet link.

In some examples, the imaging sensor 801 may operate in a frequency band of 24.05-29 GHz, while in other examples, the imaging sensor may operate in another frequency band such as 57-64 GHz or 75-85 GHZ. Many frequency bands are suitable for this application. The primary factors affecting the choice of frequency band include spectrum availability and the regulatory requirements of the country in which the sensor is operated, the availability of inexpensive transmitting and receiving chips for that frequency band, and the relative transparency of packaging materials in the selected frequency band.

Deployment of Mmwave Image Sensors within an ASRS

In some examples, a mmWave imaging sensor creates an image of the contents of a storage unit as a 2D or 3D mmWave image. Such a mmWave image may then be automatically interpreted by an analysis algorithm to extract information regarding the storage unit and its contents. Analysis algorithms may include traditional computer vision algorithms (such as object segmentation, volumetric or geometric analysis, etc.) or such analysis algorithms may also include artificial neural networks that are trained to interpret mmWave images. Additionally, human interpretation of mmWave images may also be useful in certain circumstances, for example during setup, commissioning, and debugging of an automated storage system.

The outputs of such analysis algorithms that mmWave images may then be used to update a database as described herein that comprises a mapping between a physical warehouse and its “digital twin”. In some examples, the outputs of such analysis algorithms may include the presence or absence of a storage unit at a particular physical location in an ASRS. In further examples, such outputs may be employed to determine a volumetric utilization of one or more storage units, or to determine a volumetric utilization of the ASRS as a whole. In other words, the analysis of the mmWave image may be used to determine how much space is used and how much space remains empty in the ASRS at any given time, which are useful parameters in determining the storage efficiency or utilization factor of the ASRS. In still further examples, such outputs may be employed to count items in storage units, detect missing or damaged items in storage units, and/or detect leaks within storage units.

In some examples, mmWave sensors may be deployed in fixed locations within an ASRS to scan storage units as they pass by. For example, it may not be cost-effective to deploy one mmWave sensor for each potential storage unit location, since there may be thousands or potentially millions of potential storage unit locations in a large facility. It may be more cost-effective to deploy mmWave sensors at specific scan points along the paths or tracks traversed by shuttles, bots, or robots such that storage units may be scanned as they pass the sensor. In some examples, mmWave scan points may be created at specific locations that are “choke points” through which a significant fraction of shuttle, bot, or robot traffic must pass, carrying storage units that will be imaged as they pass the sensor. Some examples of choke points may include pathways into or out of sections of the ASRS storage area, pick or stow stations, or elevators or conveyors that permit shuttles, bots, or robots to move from one level of a storage area to another.

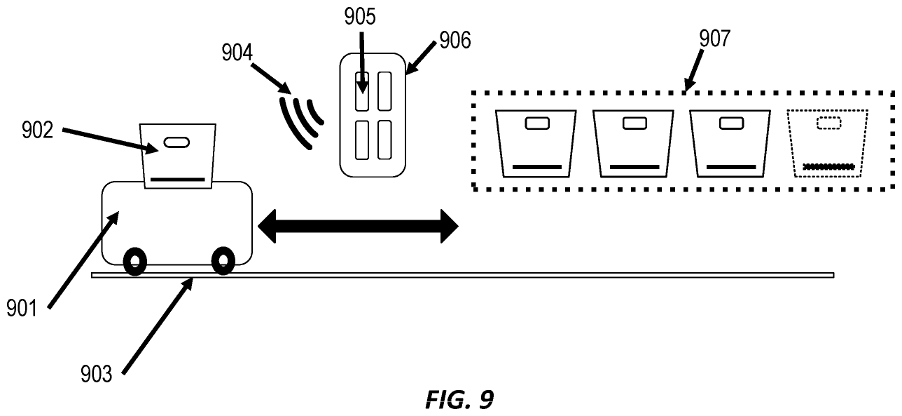

FIG. 9 shows an example of a fixed location mount for a mmWave sensor. Transport unit 901 may comprise a shuttle or bot that travels along a path 903 which may include either rails or a free-form travel route. The transport unit 901 carries storage unit 902 past fixed mounted sensor array 906 which includes mmWave sensor(s) 905. The sensor(s) emit mmWave energy 904 which is reflected from the storage unit 902 and the items inside. The reflected mmWave energy is used to form a 2D or 3D image of the contents of the storage unit 902 and/or its contents. In some examples transport unit 901 carries storage unit 902 past sensor array 906 while en route to or from storage locations 907 where the storage unit may be deposited or received.

In other examples, mmWave sensors may be integrated with a moving platform such as a shuttle, bot, or robot. In such examples, the moving platform carries the mmWave sensors along a path that enables the mmWave sensors to scan storage units that are stationary, for example storage units that have been emplaced on shelving or racking within the storage system. The mmWave sensors may then image each storage unit that the moving platform passes by.

In the examples described herein, the mmWave images may be analyzed by analysis algorithms running on an image analysis processor, and the outputs of the analysis algorithms used to update an ASRS-associated database as previously described. Analysis may be performed using mmWave images alone or in combination with other sensors, such as RGB cameras, depth cameras, infrared cameras, or sensors such as temperature or humidity sensors. Examples of analysis algorithms may include counting items shown in mmWave images, determining if specific items are present or absent in mmWave images, determining the presence of damage on one or more items in the mmWave image, detecting leaks of water or other liquids, or determining the volumetric fill level of an ASRS storage unit. In some examples, analysis algorithms may compare portions of a mmWave image against a template that is obtained from a database to determine whether there is a full or partial match between one or more items in the storage unit and the template. In each of these cases, one or more numeric outputs of the analysis algorithms may be used to update a database record pertaining to the storage unit being imaged. In some examples, the database record association may be made using a unique identifier carried by a barcode or RFID tag that is affixed to the storage unit. Such a unique identifier may sometimes be called a “license plate number” or LPN that is associated with the storage unit.

Additionally, in some examples the mmWave images may also be used to detect damage to the storage unit itself, such as dented or cracked materials that comprise the storage unit. If damage, such as a fluid leak, has occurred which may have caused damage to the storage unit, the mmWave image may be compared to a previously acquired image to determine the nature and extent of such damage.

mmWave Image Sensor Unit Mechanically Compatible with a Storage Unit

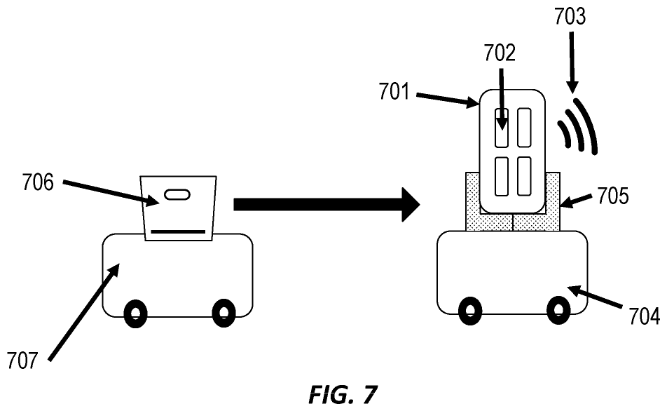

In one example shown in FIG. 7, it may be desirable to provide for mmWave imaging within an existing transport unit 707 that is not already equipped with a mmWave image sensor. In such examples, one or more mechanically compatible mmWave sensor units may be provided to enable such retrofits as described herein.

The transmitting and receiving antennas comprising the mmWave imaging sensors 702 producing mmWave signals 703 may be arranged in an array 701 and disposed on at least one face of a transport enclosure that has a similar size and shape as an existing storage unit 706. Such a mmWave sensor unit may be referred to informally as a “pig” by analogy to the self-contained, cylindrical sensor units that are sent through oil, gas, and chemical pipelines to inspect them from within. For example, to retrofit an existing tote-based transport unit 704, a sensor unit transport enclosure 705 having dimensions similar to the storage unit 706 may be used. The transport enclosure 705 may be designed in a mechanically compatible manner that allows the existing transport unit platforms to carry the enclosure, and thus to allow the transport unit to carry the mmWave sensor units through the facility without requiring any modifications of the existing transport unit. In some examples, the transport enclosure 705 may be comprised of a “core” unit including sensor array 701, plus adapters that are affixed around the core to enable compatibility with a wide variety of different storage unit sizes and form factors (e.g. different sized totes, trays, bins, or boxes). This approach of a core unit plus adapters enables an economical way to serve different transport unit types from different manufacturers. Such adapters may attach the sensor unit to the transport unit using at least one of the same attachment points as used to carry storage unit 706.

In some examples, a transport enclosure 705 may include an energy storage device such as a battery or a supercapacitor. In such examples, the sensors 702 and/or transport enclosure 705 may be placed in a charging location, such as a charging dock, when it is not being used, to allow for recharging in between periods of use. Such a charging dock may employ electrical contacts and/or inductive charging to recharge the energy storage device. Alternatively, a transport enclosure 705 may be recharged when it is placed on a transport unit (such as a shuttle) at a replenishment station.

### Recording, Processing, and Communication

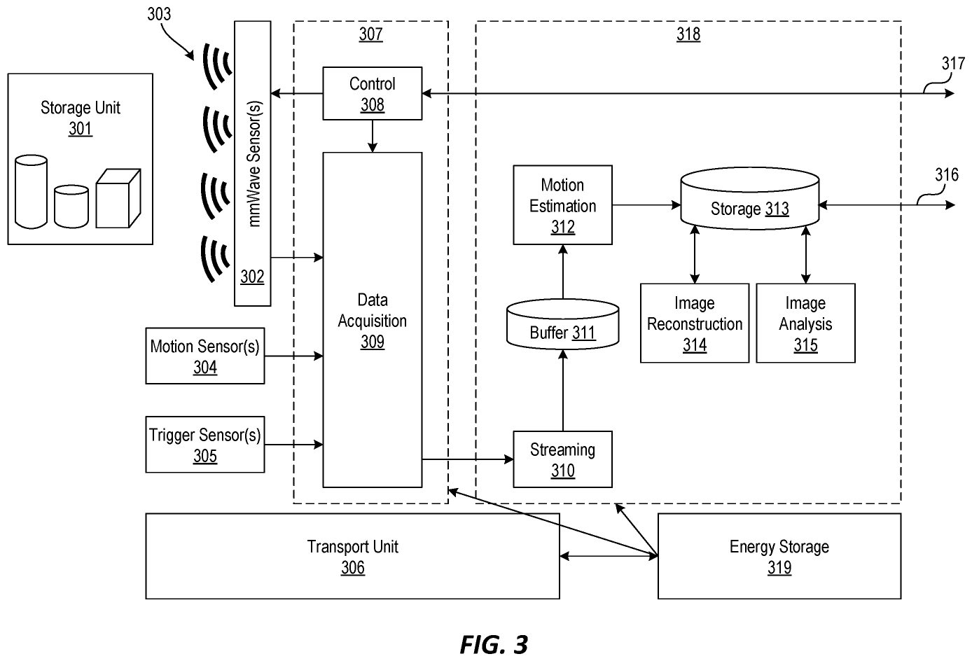

As shown in FIG. 3, in addition to the mmWave sensor(s) 302, the mmWave imaging system may also comprise a control and data acquisition system 307 comprising digital control system 308 as well as data acquisition system 309. The mmWave sensor(s) 302 may emit mmWave signals 303 which are reflected by the items present in storage unit 301 to enable imaging of such items.

Motion sensor(s) 304 may be used to track the motion of the mmWave sensor(s) 302 relative to storage unit 301. Motion sensors 304 may form an input to motion estimation system 312 that produces position estimates of the mmWave sensor(s) 302 relative to storage unit 301.

Trigger sensor(s) 305 may be employed to trigger the mmWave imaging system in response to the mmWave sensor(s) 302 reaching a particular position relative to the storage unit 301. In one example, a trigger sensor 305 may comprise an optical break-beam sensor that triggers when the storage unit 301 reaches a pre-determined distance from the mmWave sensor(s) 302. This may enable the mmWave imaging system to register a 2D or 3D mmWave image with respect to the physical location of the storage unit 301 and thus make a “freeze frame” image of the storage unit 301 and other storage units, with each storage unit appearing centered within the mmWave image.

Data acquisition system 307 enables the mmWave sensor data to be recorded as the sensor is carried through the storage system by the transport unit 306. The acquired data is transferred to processing system 318 via a data streaming system 310 that ingests mmWave data from mmWave sensors 302 via the data acquisition system 309. The processing system 318 may be connected via a wireless network link (such as a WiFi or IEEE 802.11) link to an on-premises or a cloud based processor. Such a wireless link may include a control path 317 as well as a data path 316 which may comprise one or more application programming interface(s).

In some examples, the mmWave data from the sensor units may be buffered by one or more buffers 311 and combined with position estimates from motion estimation system 312, and stored in storage unit 313. Storage unit 313 may include any form of read-write memory including random access memory (RAM), or nonvolatile memory such as Flash memory, a hard disk, or a solid state disk.

Image reconstruction processor 314 may ingest mmWave data as well as position estimates from the motion estimation system 312 and may process these inputs as described herein to produce a 2D or 3D mmWave image of the contents of storage unit 301.

The analysis algorithm(s) previously described may run on an image analysis processor 315 of the recording and processing system. In other examples, the analysis algorithm(s) may run on the on-premises processor or a cloud based processor, such algorithms being fed image data originating in the sensor unit and transferred over the wireless network link. These algorithm(s) may provide outputs to a database of the ASRS as previously described.

In some examples, where a real-time connection to an image reconstruction processor is not available, or is not desirable, the sensor unit may store sensor data in one or more batches (for example, as files or database records) in a memory such as a RAM, Flash, or hard disk storage for later download and/or use. This may be beneficial in environments in which wireless connectivity is unreliable due to attenuation or long distances between access points.

### Power for Sensor Units

The sensor unit may be completely self-contained and may appear to the storage system and transport unit as if it is a typical storage unit. In order to provide a self-contained mmWave sensor, power may be provided via energy storage device 319 such as rechargeable batteries or supercapacitors co-located with the sensor unit. To recharge the energy storage device, any of several methods may be employed. If an auxiliary power connection is available on the transport unit, a cable may be provided to enable the mmWave sensor unit to draw power and/or recharge its energy storage device via the transport unit.

If a contact-based power distribution system is used with the storage system, the mmWave sensor unit may be fitted with contacts to draw from the existing power distribution system. In some examples, mechanical projections may be fitted to the mmWave sensor unit that project out from the mmWave sensor unit and enable contact with existing storage system tracks or rails that carry power. Such mechanical projections may take the form of removeable spring-loaded “arms” that may be fitted to the sensor unit. Such “arms” may be interchangeable to accommodate different storage system tracks or rails from different vendors. Furthermore, if adapters are used to enable a “core” mmWave sensor unit to adapt to different storage system types, such adapters may also contain power contacts as described herein.

If the existing storage system relies on magnetic induction to provide power to transport units, an inductive power receiver may be fitted to the mmWave sensor unit, either internally, or via mechanical projections that enable the inductive power receiver to be disposed in sufficiently close proximity to the inductive power transmitter(s) of the storage system. Similarly, inductive power receivers may be contained in adapters as described.

### Motion Estimation

Many mmWave image sensors utilize an imaging approach wherein the image sensor forms a two dimensional or three dimensional image from a large number of pairwise transfer function measurements forming a mmWave measurement data set. The measurement data set contains the mmWave reflectivity data that are then reconstructed to form a 2-dimensional or 3-dimensional image of the items being scanned. To increase the number of available measurements, measurements may be collected at several relative positions between the mmWave sensor array and the objects comprising the scene. These measurements may be coherently combined to form a single image data set. To coherently combine data from multiple measurements, it is necessary to know the positions at which each measurement was taken.

In some examples, a motion estimation system 312 is used to connect one or more measurement data points with the position(s) at which the data was taken. In the case of linear motion along a path (whether free-form linear motion, or linear motion along a track), the motion estimation system 312 may use a combination of information from a tracking system such as an optical tracking system, a radio-frequency identification (RFID) tracking system, or a mechanical tracking system.

An optical tracking system may use a camera (such as an RGB camera, an infrared camera, or any other optical image sensor) to take image frames which contain visual features or fiducials that can be analyzed to determine the location of the sensor unit relative to those visual features. Some examples of visual features include barcodes, 2-dimensional barcodes, QR codes, stripes or patterns of one or more colors, or “naturally occurring” visual features such as distinctive objects that appear in the camera image. In some examples, multiple visual features appearing in a camera frame can be analyzed to determine a 2-dimensional or 3-dimensional position of the sensor unit relative to those visual features, which may optionally include rotation (pose angles) of the sensor unit relative to the visual features. Such a system may be referred to as a six-degree-of-freedom (6DOF) tracking system.

In some examples, RFID tags may be disposed at key locations along the path of the sensor unit, while the sensor unit may include an RFID reader, or vice versa. Such tags may transmit a unique identifier corresponding to a particular location, or they may transmit their locations in a coordinate reference system so that reading the RFID tag is sufficient to determine the location of the sensor unit. In some examples, the RFID tag and reader system may provide additional information about the relative location of the tag and reader, for example by encoding the distance between the tag and reader in the magnitude and/or phase of the radio frequency signal. In other examples, the signals from multiple RFID tags may be combined to produce a 2-dimensional, 3-dimensional, or 6DOF position estimate.

In some examples, a mechanical tracking system may comprise a regular pattern (or patterns) of holes or depressions along a track or path that are read by a switch or magnetic sensor so the sensor can determine an initial starting point and/or a distance traveled to yield a position along the linear motion path. Alternatively, a regular pattern (or patterns) of projections along the track or path may provide the same information.

An inertial measurement unit (IMU) containing accelerometers and/or gyroscopes may also be used to estimate the position of the sensor unit, alone or in combination with the other approaches described herein. When used alone, the IMU may be used as a dead-reckoning sensor to provide position estimates relative to a starting location, which in some examples may be chosen to coincide with an arbitrary position corresponding to the beginning of each mmWave data collection. The IMU and/or the motion estimation system 312 may perform a Kalman filter operation to fuse the inertial sensor data with the other sensor data to yield maximum-likelihood position estimates.

In some examples, the sensor unit may be co-located with an autonomous or semi-autonomous robotic platform, for example in a storage system that leverages free-form motion of storage units carried by an autonomous or semi-autonomous robotic platform. In such examples, the position estimates developed by the robotic platform may be leveraged by the mmWave imaging system. In such examples, position estimates generated by a simultaneous localization and mapping (SLAM) system may be used. In some examples, a robotics control system such as the Robot Operating System (ROS) may maintain an event queue of position estimates generated by the SLAM subsystem. In such examples, the mmWave imaging system may be linked to the control system and subscribe to its event queue to receive a stream of position estimates in as the robotic platform moves along a trajectory.

In other examples, the sensor unit may be fixed at a specific location while the storage units being imaged move past that fixed location, as when the storage units are moved by a conveyor belt, a shuttle unit, bot, or robot. In such examples, the relative position between the storage unit being imaged must be known. This may be accomplished by using any of the methods described herein to obtain the positions of the storage unit as a function of time. In some embodiments, where the storage unit is moved repeatably (along the same path and with the same velocity/acceleration profile), this may be easily accomplished by leveraging one or more break-beam or trigger sensors to detect that the storage unit has crossed a starting location and can then be assumed to follow a pre-determined motion path thereafter. In other embodiments, where the path is known but the storage unit velocity is not known, two or more break-beam or trigger sensors may be arranged along the path such that they trigger in a sequence as the storage unit moves along its path. The velocity of the motion of the storage unit may then be estimated from the timing of the trigger sequence by measuring the time intervals between adjacent triggers.

mmWave Image Reconstruction and Analysis

In some examples, the mmWave sensor(s) 302 may acquire multiple data samples as the sensor moves relative to the storage unit 301 being imaged. In such examples, the mmWave data samples may then be paired with position estimates generated by a motion estimation system 312 corresponding to the relative locations between the sensor unit and the items being imaged, in some examples for each data sample collected. An image reconstruction processor 314 may then be used to transform the mmWave data into a 2D or 3D image corresponding to the mmWave reflectivity of the items being imaged. Examples of image reconstruction processors 314 that may be used for this transformation include digital hardware executing a matched filter algorithm or a range migration algorithm, among many others. Such algorithms may be designed to efficiently leverage parallel processing, for example they may be optimized for efficiency on a multi-core central processing unit (CPU) or a many-core graphics processing unit (GPU).

In some examples, the image reconstruction processor 314 may run on processor hardware that is co-located with the sensor unit 302, for example in the form of an embedded personal computer (PC) that is mounted alongside the mmWave sensor 302 itself.

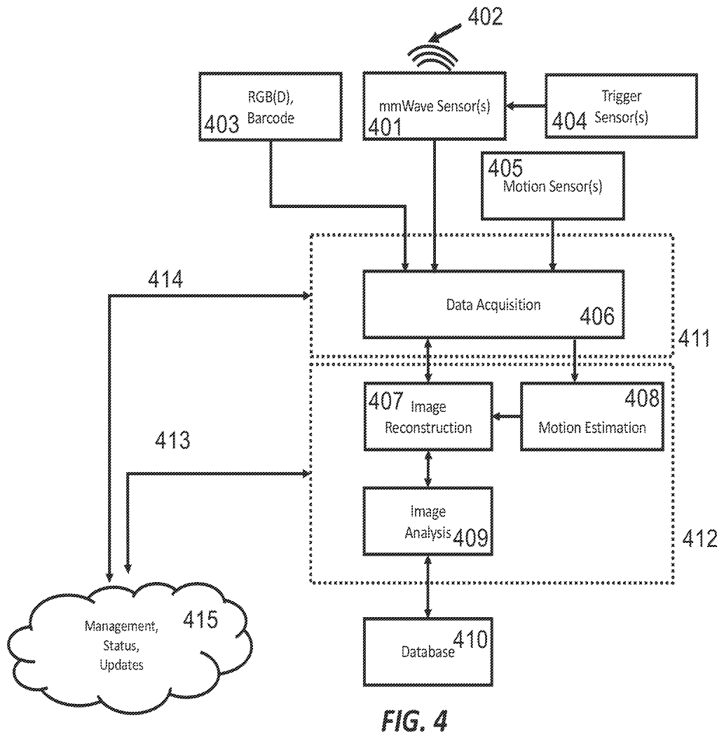

As shown in FIG. 4, in further examples, processor hardware may be centrally located on-premises at a particular warehouse facility. In such examples, a wired or wireless network may be used to carry the mmWave sensor data from mmWave sensor(s) 401, trigger sensor(s) 404, other sensors 403, and the outputs of the motion sensor system 405 from data acquisition system 406 and processor 411 to centrally located processor hardware 412 for the image reconstruction and/or analysis 407 and 409. The outputs of image analysis system 409 may be communicated to a database 410. A management interface 415 may be either on-premises or cloud-based and may leverage wired or wireless communication links 413 and 414 to carry supervisory information to the management interface 415. Software updates for the data acquisition system 406 and processor 411, as well as image reconstruction 407, motion estimation system 408, and image analysis system 409 and processor 412 may be carried by a wired or wireless network from a management interface 415.

This approach may be economically advantageous when the duty cycle of any single imaging system is relatively low, for example when there is a significant inter-arrival interval between the storage units being imaged. In such cases, processor hardware 412 can easily be shared among several imaging systems. The outputs of the image reconstruction and/or analysis may then be integrated via application programming interfaces (APIs) with a database 410 such as a warehouse management system (WMS) or warehouse execution system (WES). Records may be exchanged with the WMS or WES in standardized record formats such as Javascript Object Notation (JSON) records.

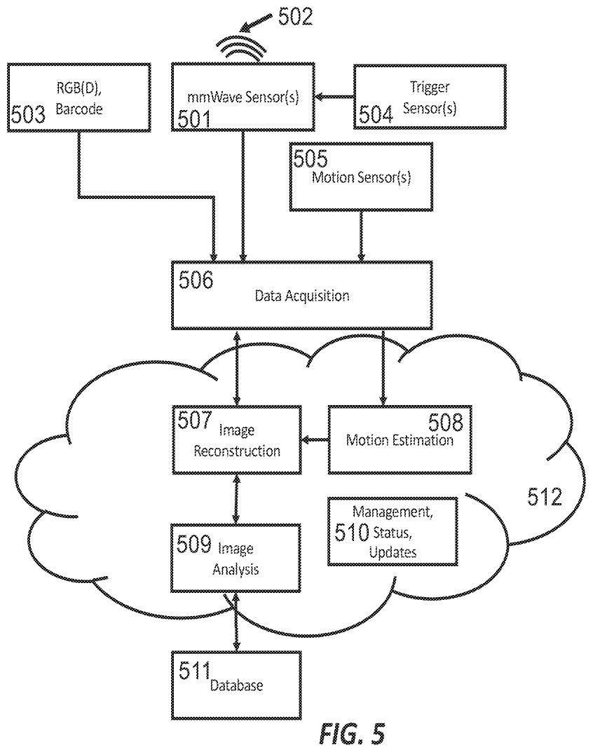

In still further examples, as shown in FIG. 5, cloud computing infrastructure 512, such as that offered by Amazon Web Services, Microsoft's Azure, or Google Cloud Services, may be employed to perform the image reconstruction 507, motion estimation 508, and/or image analysis 510. A management interface 510 may also be hosted by cloud computing infrastructure 512. In such examples, a wired or wireless network may be used to carry the mmWave sensor data from mmWave sensor(s) 501, trigger sensor(s) 504, motion sensor(s) 505, and other sensors 503 to one or more virtual machines instantiated in the cloud computing infrastructure 512. In some examples, virtual machines hosted on hardware including multi-core CPUs or GPUs may be used to accelerate the image reconstruction and/or analysis tasks. In some examples, the cloud infrastructure may then interface with a database 511 such as a WMS or WES via one or more cloud-based APIs. Records may be exchanged with the WMS or WES in standardized record formats such as JSON records.

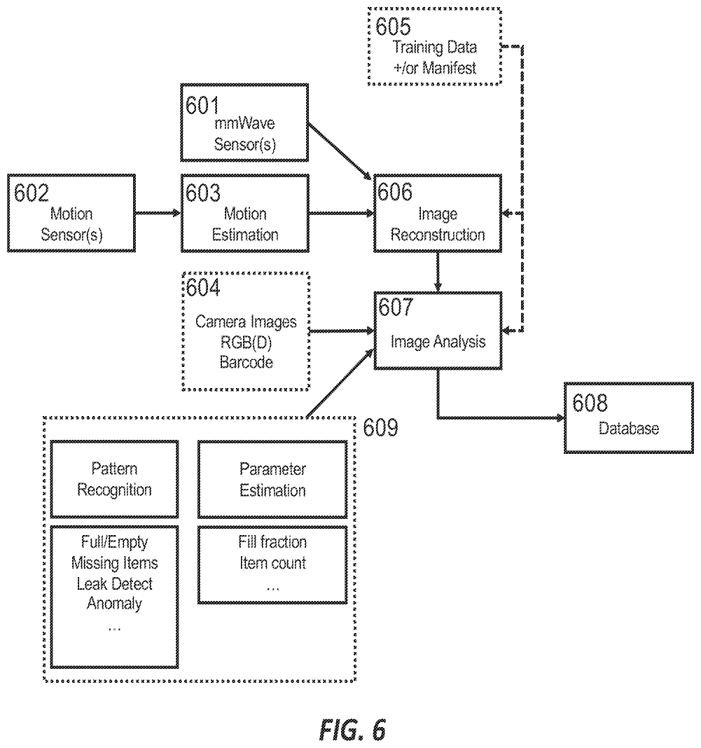

As shown in FIG. 6, in some examples, image analysis system 607 may support multiple analysis modules 609. For example, a pattern recognition module may compare an image against a library of previously acquired images to determine if a change, anomaly, or discrepancy has occurred. Examples of changes, anomalies, or discrepancies may include whether a storage unit (e.g. a box or tote) is full or empty, whether there are items missing, whether there are fluid leaks, or other anomalies. In some examples, a parameter estimation module may be employed to estimate a process variable or parameter, for example to estimate the fill level of a storage unit, or to estimate an item count, based at least in part on a mmWave image.

Analysis modules 609 may employ training data 605 to train or calibrate the underlying algorithms used by the analysis modules. Examples of such algorithms include computer vision algorithms (such as object segmentation algorithms, edge detection algorithms, clustering algorithms, etc.) as well as machine learning algorithms based including neural networks. In some examples, training data 605 may be used to tune the weights of interconnections in neural networks. In some examples, training data 605 may be used in a supervised manner and may comprise a set of mmWave images for which the expected analysis result is known and provided in the form of labels, for example a set of mmWave images for which the number of items in each image is known, or a set of mmWave images known to represent storage units having a fluid leak, or not. In other examples, training data 605 may be used in an unsupervised approach. An example of an unsupervised approach may include training data 605 comprising a large number of example images, many of which are identical (within practical tolerances) but with some also containing anomalies. In such unsupervised examples, labels may not be provided and an analysis module 609 may be expected to self-discover the anomaly cases. In further examples, training data 605 may include mmWave images paired with a manifest from a database such as a WMS or WES for which the database entries may comprise at least in part the labels for the training data. In some examples, the manifest is retrieved in response to barcode data scanned from a label affixed to a storage unit (such as a LPN).

The result(s) of analysis modules 609 may be conveyed by image analysis system 607 to database 608 which may comprise a WMS, WES, or other database.

### CONCLUSIONS

In some embodiments, an automated storage and retrieval system (ASRS) may comprise a collection of individual storage units such as totes, bins, trays, or boxes, each of which may be used to store items for later retrieval. One aspect of an ASRS is a database comprising records pertaining to the contents of the storage units and to the logical and/or physical locations of the storage units within the system. Examples of ASRS comprising one or more millimeter wave (mmWave) imaging sensors are described, in which ASRS database records are updated at least in part due to outputs of mmWave imaging sensors. In some examples, mmWave imaging sensors are employed to sense the presence or absence of an item or a storage unit at a particular physical location in an ASRS. In further examples, mmWave imaging sensors are employed to determine a volumetric utilization of one or more storage units, or to determine a volumetric utilization of the ASRS as a whole. In still further examples, mmWave imaging sensors are employed to count items in storage units, detect missing or damaged items in storage units, and/or detect leaks within storage units. mmWave imaging sensors may have a form factor similar to a storage unit, enabling the ASRS transport units to carry the sensors throughout the volume of the ASRS and thus enable the sensors to scan the contents of other storage units while the sensors are carried throughout the system.

What is claimed is:

1. A system for producing a millimeter wave image of an object, the system comprising:
a storage unit comprising a material at least partially transparent to millimeter waves and configured to contain the object;
a millimeter wave sensor providing millimeter wave data, the sensor comprising:
an array of millimeter wave transmitting antennas; and
an array of millimeter wave receiving antennas;
one or more processors; and
one or more memory devices having stored thereon instructions that when executed by the one or more processors cause the one or more processors to:
receive the millimeter wave data from the sensor;
generate estimated positions of the millimeter wave sensor relative to the storage unit, wherein the millimeter wave sensor and the storage unit are in relative motion; and
process the millimeter wave data and the estimated positions to produce the millimeter wave image of the object.

2. The system of claim 1 wherein the storage unit is carried by a transport unit.

3. The system of claim 1 wherein the millimeter wave sensor is carried by a transport unit.

4. The system of claim 1 wherein the millimeter wave sensor is carried by a first transport unit and the storage unit is carried by a second transport unit.

5. The system of claim 1 further comprising instructions to uplink the millimeter wave image to an image analysis processor via a wireless network.

6. The system of claim 1 wherein the millimeter wave sensor is disposed on at least one face of a transport enclosure that has substantially the same size and shape as the storage unit and wherein the transport enclosure is carried by a transport unit.

7. The system of claim 6 wherein the one or more processors are contained within the transport enclosure and further comprising instructions to uplink the millimeter wave image to an image analysis processor via a wireless network.

8. The system of claim 6 wherein the transport enclosure comprises an adapter that enables the millimeter wave sensor to mechanically connect to the transport unit using at least one attachment point in common with the storage unit.

9. The system of claim 3 wherein the millimeter wave sensor is powered by a battery or supercapacitor carried by the transport unit and wherein the battery or supercapacitor is recharged by electrical contact or by magnetic induction.

10. The system of claim 1 wherein an image analysis processor is co-located with the processor.

11. The system of claim 1 wherein the one or more processors is instantiated in a virtual machine of a cloud computing service.

12. The system of claim 10 wherein the image analysis processor is instantiated in a virtual machine of a cloud computing service.

13. The system of claim 1 further comprising a motion estimation system that comprises an optical tracking system wherein the estimated positions are determined by reference to a visual feature.

14. The system of claim 13 wherein the visual feature comprises a barcode, a QR code, or a two-dimensional barcode.

15. The system of claim 1 further comprising a motion estimation system that comprises an RFID tracking system wherein the estimated positions are determined by reference to an RFID tag.

16. The system of claim 2 further comprising a motion estimation system that comprises a regular pattern of holes, depressions, or projections along a path traveled by the transport unit, wherein the regular pattern of holes, depressions, or projections are read by a switch, a magnetic sensor, or an optical sensor.

17. The system of claim 1 further comprising a motion estimation system that comprises an inertial measurement unit and wherein the estimated positions are determined at least in part by the inertial measurement unit.

18. The system of claim 1 further comprising instructions to determine an estimated volume utilization of the storage unit based at least in part upon the millimeter wave image.

19. The system of claim 1 further comprising instructions to compare the millimeter wave image of the storage unit to a previously acquired millimeter wave image of one or more items expected to be present within the storage unit and wherein a result of the comparison is used to update a database entry associated with the storage unit to include the result.

20. The system of claim 1 wherein an output of the one or more processors is used to update a database entry associated with the storage unit to include an item count, an indication of a missing item, an indication of a damaged item, an indication of damage to the storage unit, or an indication of a liquid leak, at least in part due to the millimeter wave image of the storage unit.
